(19) United States
(12) Patent Application Publication
(10) Pub. No.: US 2016/0086066 A1
(43) Pub. Date: Mar. 24, 2016

(54) Printing of Security Devices

(71) Applicant: LUMENCO LLC, Englewood, CO (US)

(72) Inventors: Hector Andres Porras Soto, Englewood, CO (US); Mark A. Raymond, Littleton, CO (US)

(73) Assignee: Lumenco LLC, Englewood, CO (US)

(21) Appl. No.: 14/890,087

(22) PCT Filed: May 16, 2014
(86) PCT No.: PCT/US2014/038417

§ 371 Date: Nov. 9, 2015

Related U.S. Application Data
(60) Provisional application No. 61/824,134, filed on May 16, 2013.

(30) Foreign Application Priority Data
Nov. 7, 2013 (AU) 2013101454

(51) Int. Cl. G06K 15/02; B42D 25/342; G02B 3/00

(52) U.S. Cl. CPC G06K 15/1868; G06K 15/1881; G02B 3/005; B42D 25/342

(57) ABSTRACT

A computer-implemented method of preparing a digital image file or files for lenticular printing involves selectively blanking pixels of multiples images that are or are to comprise a composite interlaced image file for lenticular printing, such that the blanked pixels are distributed amongst the multiple images in successive complementary pixel sets distributed across the composite interlaced image file. As a result, the data integrity of the file is maintained, and the multiple images are represented in the composite interlaced image file without loss of information.

### FIELD OF THE INVENTION

The present invention relates to improved printing techniques for images, and in particular images for use in lenticular printing, that is, the printing of a set of images for use with lenticular lenses.

### BACKGROUND OF THE INVENTION

The printing process, whether offset or gravure provides more ink volume than is needed or wanted to the print substrate. While the file creating the art to be printed may be “perfect”, and the plates or cylinders may accurately represent that file, as the print is transferred from the plate to the blanket in offset and then to the print substrate there is “gain” or unwanted distortion, which is variously referred to as dot gain or press gain.

Dot gain (also known as tonal value increase) is a phenomenon in offset lithography and some other forms of printing which causes printed material to look darker than intended. Gain is caused by halftone dots growing in area (the ink spreading outside of the intended boundaries) between the original printing film and the final printed result. In practice, this means that an image that has not been adjusted to account for dot gain typically appears too dark, fuzzy or indistinct when printed.

The same is true in the gravure process (a cylinder-to-substrate process), in which a cylinder is engraved with the image to be printed. The engraving consists of many dots with depths corresponding to the intended ink density in the region, or alternatively the number of dots per area is varied. The cylinder is rotated through an ink (ink fountain), so that the ink fills the dots. The rotation continues, and the excess ink is wiped off the cylinder. The substrate (in a sheet) is then pressed between the cylinder and another cylinder, transferring the ink onto the substrate.

Existing methods to decrease or accommodate press gain, referred to above, are to create colour “curves” within a computer colour profile. The original file, even if it is a solid colour, is run through the profile in such a way that a 100% pixel now becomes a 70% pixel, for example. The exact form of a dot gain curve is difficult to model on the basis of geometry, and empirical modelling is used instead. That is, the curve form and its parameters are not determined from physical aspects of image microstructure and first principles. Curves such as polynomials, cubic splines, and interpolation curves may be used, and are completely empirical, as they do not involve any image-related parameters.

As the computer curve profile performs this data interpolation, the profile must render the data through a screening program, converting the pixel to 70% or similar), but also changing its size and shape according to other selected parameters available in the plate setter or engraver.

Printing interlaced files behind microlens arrays, used as security devices, introduces its own specific challenges. Such printing requires accuracy arising from the fine detail required of this work, and the manner in which it is used.

Selections available in existing computer curve profiles tend to be limited, and do not suit the particular requirements of printing for a lenticular lens arrays, and as a result, unsatisfactory compromises inevitably need to be made.

An example of this may be that an ideal selection for the microlens array maybe 400 lines per inch, but the highest setting available is perhaps 312 lines per inch.

Such compromises degrades the file/data integrity following application of a computer curve profile, which presently is the existing technique for accommodating press gain, to suitable reduce the amount of ink onto the substrate. When a computer curve profile is applied, the original file is converted to a grayscale file. For example, FIG. 1 shows an original interlaced image 2, which is then converted to a grayscale image 4, when a curve profile is applied. The grayscale file is then processed by a raster image processor (RIP), which produces a raw binary output bitmap required for printing. The RIP converts the grayscale image to an equivalent black and white image, that is, non-inked areas are created. Different methods of conversion by a RIP can produce different results. For example, one method of converting a 50% grey image would be to have equal amounts of black and white in a regular fashion. In the example in FIG. 1, bitmap image 8 is a processed version of grayscale image 4 using a straightforward regular replacement procedure. Another method may use a stochastic algorithm, so that the regularity is removed from the image, which is more likely to be seen by the human eye. Bitmap image 6 is a processed version of grayscale image 4 using a stochastic algorithm. Regardless, the process results in the image file being degraded in quality, that is original information is removed to compensate for dot gain.

This degradation does not represent any particular problem for conventional print jobs, and consequently the use of computer curve profiles is satisfactory for such applications.

For interlaced images and lenticular printing, however, this degradation is problematic. Due to the characteristics of lenticular lens arrays, which in effect amplify the underlying printed matter, print accuracy is of more critical concern. Dot gain in a printed, interlaced image behind a lenticular lens causes over fill of the interlaced channels or images and results in blurry or fuzzy images, which is not commercially acceptable.

There is a need in view of the foregoing for improved printing techniques that at least attempt to address prevailing limitations associated with printing interlaced images for use behind lenticular lens arrays.

### DEFINITIONS

### Security Document or Token

As used herein the term security documents and tokens includes all types of documents and tokens of value and identification documents including, but not limited to the following: items of currency such as banknotes and coins, credit cards, cheques, passports, identity cards, securities and share certificates, driver's licenses, deeds of title, travel documents such as airline and train tickets, entrance cards and tickets, birth, death and marriage certificates, and academic transcripts.

The invention is particularly, but not exclusively, applicable to security documents or tokens such as banknotes or identification documents such as identity cards or passports formed from a substrate to which one or more layers of printing are applied. The diffraction gratings and optically variable devices described herein may also have application in other products, such as packaging.

### Security Device or Feature

As used herein the term security device or feature includes any one of a large number of security devices, elements or features intended to protect the security document or token from counterfeiting, copying, alteration or tampering. Security devices or features may be provided in or on the substrate of the security document or in or on one or more layers applied to the base substrate, and may take a wide variety of forms, such as security threads embedded in layers of the security document; security inks such as fluorescent, luminescent and phosphorescent inks, metallic inks, iridescent inks, photochromic, thermochromic, hydrochromic or piezochromic inks; printed and embossed features, including relief structures; interference layers; liquid crystal devices; lenses and lenticular structures; optically variable devices (OVDs) such as diffractive devices including diffraction gratings, holograms and diffractive optical elements (DOEs).

### Substrate

As used herein, the term substrate refers to the base material from which the security document or token is formed. The base material may be paper or other fibrous material such as cellulose; a plastic or polymeric material including but not limited to polypropylene (PP), polyethylene (PE), polycarbonate (PC), polyvinyl chloride (PVC), polyethylene terephthalate (PET); or a composite material of two or more materials, such as a laminate of paper and at least one plastic material, or of two or more polymeric materials.

### Transparent Windows and Half Windows

As used herein the term window refers to a transparent or translucent area in the security document compared to the substantially opaque region to which printing is applied. The window may be fully transparent so that it allows the transmission of light substantially unaffected, or it may be partly transparent or translucent partially allowing the transmission of light but without allowing objects to be seen clearly through the window area.

A window area may be formed in a polymeric security document which has at least one layer of transparent polymeric material and one or more opacifying layers applied to at least one side of a transparent polymeric substrate, by omitting least one opacifying layer in the region forming the window area. If opacifying layers are applied to both sides of a transparent substrate a fully transparent window may be formed by omitting the opacifying layers on both sides of the transparent substrate in the window area.

A partly transparent or translucent area, hereinafter referred to as a “half-window”, may be formed in a polymeric security document which has opacifying layers on both sides by omitting the opacifying layers on one side only of the security document in the window area so that the “half-window” is not fully transparent, but allows some light to pass through without allowing objects to be viewed clearly through the half-window.

Alternatively, it is possible for the substrates to be formed from an substantially opaque material, such as paper or fibrous material, with an insert of transparent plastics material inserted into a cut-out, or recess in the paper or fibrous substrate to form a transparent window or a translucent half-window area.

### Opacifying Layers

One or more opacifying layers may be applied to a transparent substrate to increase the opacity of the security document. An opacifying layer is such that L_{T}<L₀, where L₀ is the amount of light incident on the document, and L_{T} is the amount of light transmitted through the document. An opacifying layer may comprise any one or more of a variety of opacifying coatings. For example, the opacifying coatings may comprise a pigment, such as titanium dioxide, dispersed within a binder or carrier of heat-activated cross-linkable polymeric material. Alternatively, a substrate of transparent plastic material could be sandwiched between opacifying layers of paper or other partially or substantially opaque material to which indicia may be subsequently printed or otherwise applied.

### Lenticular Lenses and Lenticular Printing

A lenticular lens is an array of magnifying lenses, designed so that when viewed from slightly different angles, different images are magnified. The most common example is the lenses used in lenticular printing, where the technology is used to give an illusion of depth, or to make images that appear to change or move as the image is viewed from different angles. A lenticular lens can be a one dimensional array of, usually, cylindrical lenses or a two dimensional array of, usually, spherical lenses. Lenticular printing is a multi-step process consisting of creating a lenticular image from at least two existing images, and combining it with a lenticular lens. This process can be used to create various frames of animation (for a motion effect), offsetting the various layers at different increments (for a 3D effect), or simply to show a set of alternate images which may appear to transform into each other.

### Interlaced Images

An interlaced image is a composite image or two or more images which have been interlaced together. Interlacing, typically, means slicing each of the images up along an axis at regular spacing and interleaving those slices with the spatially corresponding slices of other images. In this manner, when an interlaced image is placed under an appropriate lenticular lens, each of the images that make up the interlaced image are viewable at different angles. An interlace, as described herein, is made up of one slice from each of the images.

### SUMMARY OF THE INVENTION

The inventive concept resides in a recognition that the printing of a set of interlaced images for use in conjunction with a lenticular lenses can be advantageously improved by suitable pre-printing manipulation of the image data that selectively blanking pixels in different frames as a means of compensating for dot gain phenomena that occurs when printing such images.

Blanking pixels involves, of course, overwriting their value with zero, or whatever value is accepted by prevailing convention that is representative of whitespace at which position no ink is printed to the substrate.

Advantageously, the present invention involves selective removal of data points in at least one axis, though preferably both axes of a two-dimensional image. The techniques of the present invention find suitable application in any form of press, gravure or offset printing application, and reduce the effects of press gain phenomena, which are detrimental to accurate reproduction.

Embodiments of the invention allow the image data is to be maintained in a pristine form, in informational terms, without, or with minimal, degradation of the underlying data, and avoids, for example, use of data interpolation or similar techniques.

According to a first aspect of the present invention, there is provided a method of generating an interlaced image which is compensated for dot gain for a lenticular device, the method including: providing an initial interlaced image consisting of an array of pixels and containing a plurality of images interlaced together, each interlace consisting of at least one pixel from each image; and selectively blanking pixels from at least two of the plurality of interlaced images spatially across the initial interlaced image to generate the compensated interlaced image.

“Across” in this context means in a manner which encompasses at least two of the plurality of interlaced images.

Preferably, the step of selectively blanking pixels, alternately blanks pixels in a sequence from the at least two of the interlaced images.

Preferably, an interlace set corresponds to a defined number of interlaces, such that the total number of interlace sets is equal to the total number of interlaces divided by a predefined divisor, the predefined divisor being the number of images interlaced together in the interlaced image or an integer less than the number of interlaced images, such that a whole number of interlace sets results, and the step of selectively blanking pixels alternately blanks pixels in a sequence across each interlace set.

Preferably, the step of selectively blanking pixels selectively blanks pixels from a number of interlaced images equal to the predefined divisor in each interlaced set.

Preferably, if the predefined divisor is less than the number of interlaced images, a different set of the interlaced images are blanked in each step of selectively blanking across the interlace set.

Typically, the initial interlaced image will include a two dimensional array of pixels in a “row” and “column” format, Assuming that the interlaces of each of the plurality of images are in the same directions as the columns, each row of pixels contains information from each of the plurality of interlaced images and the selective blanking referred to above can occur along each pixel row.

Preferably, if the predefined divisor is less than the number of interlaced images, at least one alternative sequence of selective blanking is used for different pixel rows in each step of selectively blanking across the interlace set.

Preferably, the method further includes the step of selectively blanking pixels from a predefined number of pixel rows orthogonally from the previous step of selectively blanking. According to a second aspect of the present invention, there is provided a computer implemented method of generating a compensated interlaced image according to the method of the first aspect of the present invention.

According to a third aspect of the present invention, there is provided a compensated interlaced image generated according to the method of the first aspect of the present invention or the computer implemented method of the second aspect of the present invention.

According to a fourth aspect of the present invention, there is provided a security device including a lenticular lens arranged over lenticular printing of a compensated interlaced file according to the third aspect of the present invention.

According to a fifth aspect of the present invention, there is provided a security document including a security device according to the fourth aspect of the present invention.

One advantage of preferred embodiments of the present invention is to permit allow the removal of pixels while maintaining the image and informational integrity of the file, which may be processed by different software programs or algorithms. No pixel is modified, rather selected pixels are removed from specific positions that do not compromise overall image integrity or, other words, not ultimately represent a loss of information. Selective, targeted removal allows a reduction in the amount of ink onto the substrate and much better reproduction of interlaced images in a lenticular lens, which in turn reduces the effects of dot gain phenomena adversely affecting the quality of image reproduction.

Images are can be reproduced with improved fidelity, without the adverse effects of dot gain phenomena becoming so apparent.

The techniques described herein find particular application to the printing of security devices or verification devices comprising an interlaced image printed under a lenticular lens array, such as used in security documents such as banknotes.

### DESCRIPTION OF DRAWINGS

FIG. 1 shows a prior art process of compensating for dot gain in images to be printed.

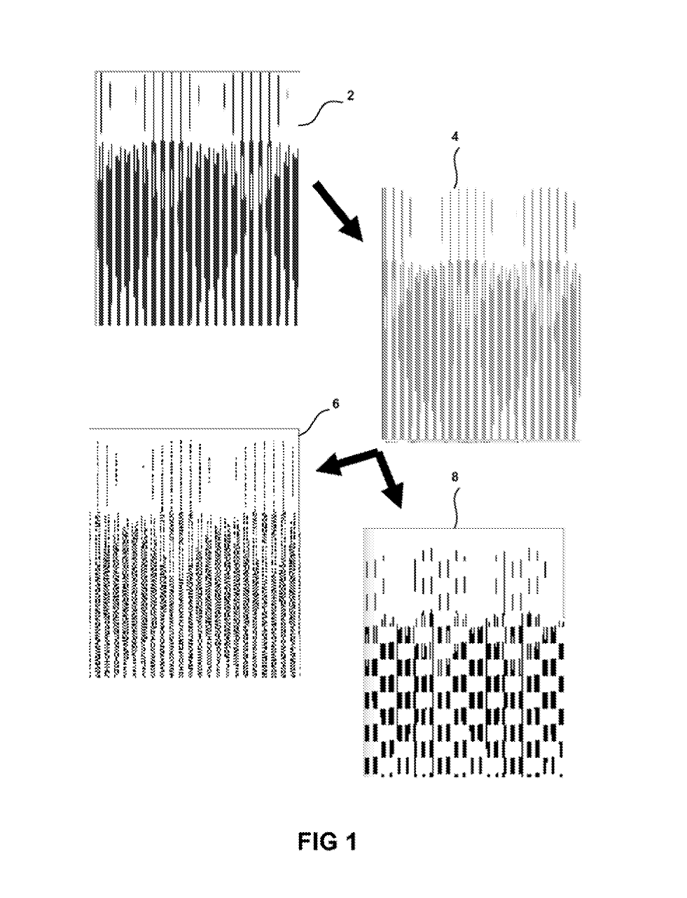

FIG. 2 is a flow chart of steps for assessing the dot gain of a composite interlaced image file used for lenticular printing.

FIG. 3 shows a schematic of a row of pixels with corresponding lenses with pixels selectively blanked.

FIG. 4 is a screen shot that depicts a composite interlaced image file comprising a sequence of six images (“straight six”).

FIG. 5 is a screen shot that depicts the composite interlaced image file of FIG. 2, but with selective blanking of pixels along one axis in accordance with an embodiment of the present invention.

FIG. 6 is a screen shot that depicts further selective blanking of pixels, applied to the image depicted in FIG. 5, in both axes, in accordance with an embodiment of the present invention.

FIG. 7 is a schematic diagram that represents the relation between constituent images and complementary pixel sets in a composite interlaced image file.

### DESCRIPTION OF PREFERRED EMBODIMENTS

A method of addressing dot gain in interlaced images is disclosed. The method involves pre-printing manipulation of the image data that selectively blanking pixels in different frames as a means of compensating for dot gain phenomena that occurs when printing such images.

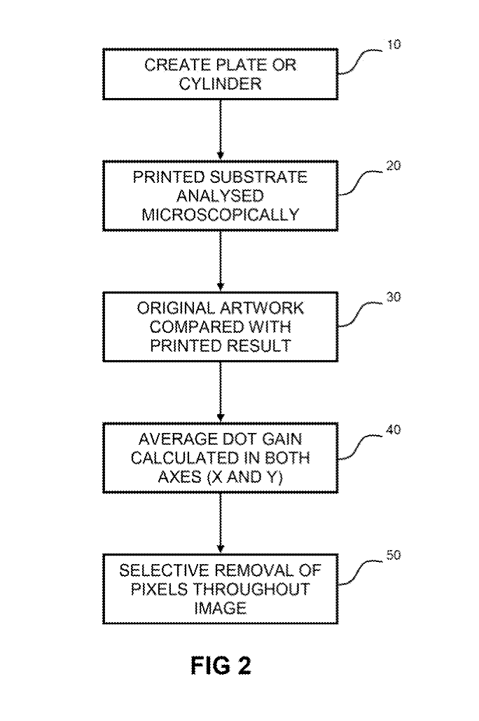

FIG. 2 depicts in overview, by means of a flow chart, steps involved in assessing dot gain of a composite interlaced image prepared for lenticular printing. A manual image preparation process is conducted, followed by subsequent analysis of data arising from the manual image preparation. First, a “fingerprint” of the press is taken by using the plate setter to create a plate or cylinder, in step 10. Next, the substrate is printed with a series of lines, spots, interlaced images and other images, according to the artwork created in step 10, in step 20.

The substrate is then analysed microscopically, and the original screenshot and/or plate of the file is then compared to the actual print in step 30. An average “dot gain” calculation can be made based upon the spread of the ink, line or dot in two axes (X and Y) in step 40. Next, the dot gain can be compensated for by removing pixels from the interlaced file in step 50, in accordance with techniques described herein in further detail below. The percentage of removed pixels being based on the results of the average “dot gain” calculation discussed in relation to step 40.

Other methods of assessing the appropriate amount of pixels to be removed are also relevant. For example, a simple trial and error process would allow an appropriate level of reduction to be achieved prior to a production run.

While there are some compromises, based upon the divisibility of images relative to the plate setter, the information and sequencing ensures removal of pixel information is relatively “even”, in spatial terms, leaving the informational content of the image file intact, such that the final print produces the desired image (the dot gain, in general, compensating for the removal of pixel information). The dot gain percentages discussed below are as an example only and other percentages may be appropriate for the particular printer being used.

Dot gain is typically over 25% in small pixel reproduction, regardless of the particular printing technique used and gain of 33% or more is not uncommon.

Consider the following example, it is planned to print interlaced images with a 2400 DPI (Dots Per Inch) plate setter (that is, the resolution of the printer that will be used is 2400 DPI). Using a lenticular lens array of 400 LPI (Lenses Per Inch) results in an initial interlaced image of six images (that is, 2400/400=6), forming a composite interlaced image. In this example, the required dot gain compensation is about 16% in each direction (the X and Y axis).

One approach for addressing dot gain phenomena is as follows. Removal of one of the images from the initial interlaced image results in a one-sixth (that is, 16.66%) decrease in data, which is satisfactory to provide some compensation for dot gain phenomena. This approach, however, also has the undesirable consequence of eliminating this same proportion of information from the image, and thus adversely affect print reproduction quality. The image sequence in this case can be represented as X23456, where X=blank. Image #1 is eliminated, and gone forever, and the image when viewed through the lenticular lens would, as a consequence, not reproduce satisfactorily.

Data integrity can be improved in the image used for lenticular printing by adopting the following technique, described below.

In addition to an interlace (a slice of the interlaced image which contains information from all images, six in this example), an interlace set is introduced which is a predefined multiple of interlaces. For each pixel row of the interlace set a blank position alternates between the respective interlaces that form the composite interlaced image. Ideally, the print resolution of the composite interlaced image is an integer divisor of the resolution of the lenticular lens.

Therefore, for a lenticular lens having a frequency of 400 LPI, the ideal number would be to alternate the position of the “blank” pixel in each interlace of an interlace set that is associated with a lens, and since there are 6 images associated with each interlace in this example, having 6 interlaces in an interlace set would be ideal. Since the use of 6 interlace sets gives us a fractional result (400/6=66.66), this is not convenient for data processing purposes, Therefore, in this example, the nearest integer that produces a whole result is chosen, which is, 5 (that is, 400/5=80), which provides convenient data processing. This modification makes it easier to use any suitable software program to perform interlacing operations.

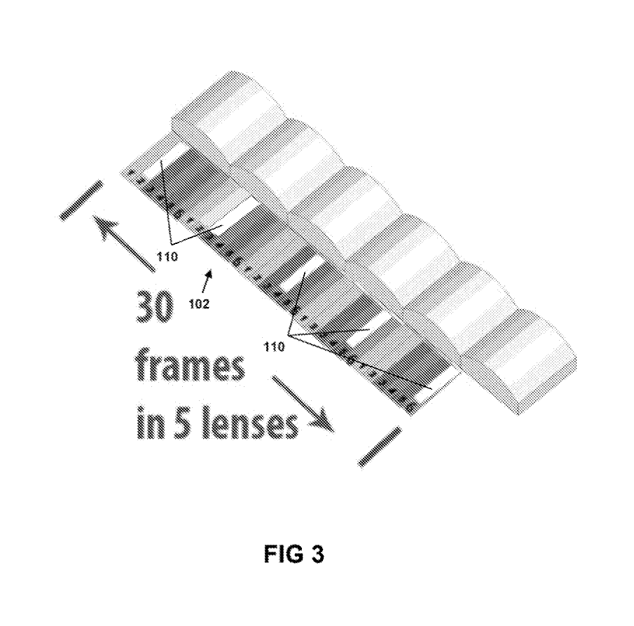

To illustrate the above, FIG. 3 shows lenses 100 of a lenticular array with an illustrative row of pixels 102. The pixels are from 6 interlaced images and are shown corresponding to 5 lenses, therefore forming an interlace set of 5 interlaces. In each interlace there are blanked pixels 110. In this case, the first interlace has the pixel from the second image blanked, the second interlace has the pixel from the third image blanked, and so on. When a new interlace set is reached, the above process would be repeated.

With reference to the directly preceding paragraphs, the following sequence of blanks is adopted, as set forth in Table 1 below.

TABLE 1

| LENS SET | BLANK PATTERN IMAGE |
|---|---|
| NUMBER | SEQUENCE |
| 1. | 1X3456 |
| 2. | 12X456 |
| 3. | 123X56 |
| 4. | 1234X6 |
| 5. | 12345X |

The implication of the sequences set forth in Table is that 6 images per lenticular lens, multiplied by an interlace set of 5, results in a repeating pattern every 30 pixels (as shown in FIG. 3). The interlace set of 5 interlaces corresponds to 80 interlace sets per inch (40015=80), and 30 pixels are depicted in each interlace set, which equates with the target print resolution of 2400 DPI (30*80=2400).

Using this technique, all of the interlaced images remain, and moreover, the interlaced image #1 is never “blanked”, and remains at full strength to the viewer. This arises, as described above, due to the fact that the numbers in the example required a pragmatic departure from using an even divisor. One could choose another of the images that have been interlaced to avoid replacing with a blank frame: the choice is an arbitrary one, from a technical perspective.

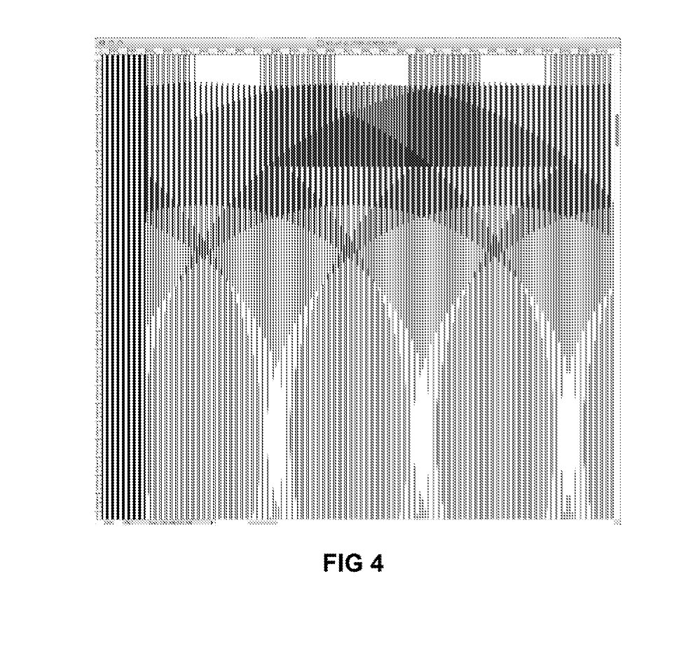

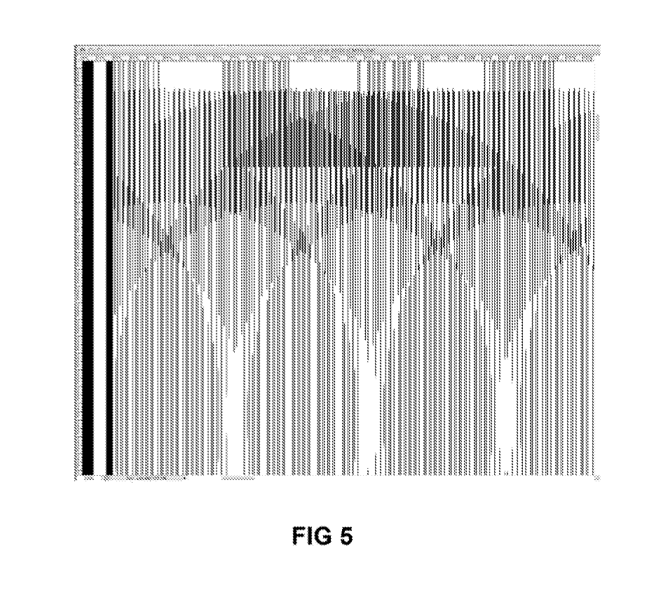

FIG. 4 depicts a computer interface screen shot which represents a straight 6 image interlaced sequence, and FIG. 5 provides a similar representation that uses the technique described above, to create a compensated interlaced image ready for printing. Less ink is printed to the substrate to compensate for dot/press gain, but the effect does not interrupt the viewing of the images through a lenticular array in the same manner as the conventional methods.

The resulting compensated interlaced image can also be processed in the y-axis (90 degrees from the axis of the image referred to above), thereby ensuring that the desired reduction of pixels are similarly reduced from the Y-axis. In the Y-axis direction, the rows of pixels include pixels from each of the interlaced images. If a row of pixels is removed from the interlaced image it will affect all the interlaced frames in the same way and does not result in removing an image from an interlaced set.

Preferably, since we have already removed approximately one-sixth of the data in the X-axis, one-sixth can also removed in the Y-axis, some blanks are of course placed where they already exist. As a result, the total reduction in pixels in the image file falls short of a cumulative one-third, but is actually closer to, say, 30% in reduction. This proportion is sufficient to provide adequate reduction in dot gain phenomena for the application at hand.

However, because removing an entire row of pixels in the Y axis does not affect the individual images of the composite interlaced image in a different manner, any percentage of rows can be removed, and the ink can be further reduced by an arbitrary percentage.

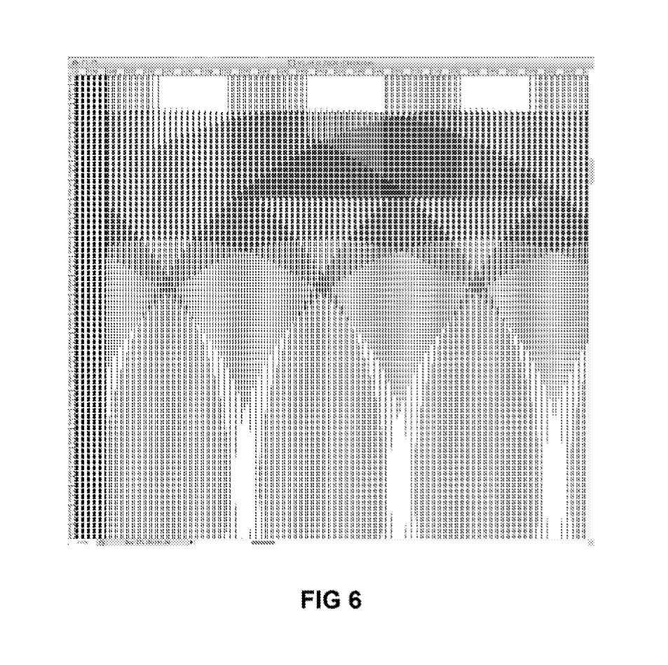

FIG. 6 depicts rows of pixels removed in the y-axis (one row removed ever six rows, reducing the number of pixels by a sixth), further reducing the “lay down” of ink onto the substrate, yet the shape and placement of the compensated interlaced image remains high. The result of applying the method to an image file in the example above provides exactly 2400×2400 DPI and have precisely and evenly removed data yet kept the integrity of the image without existing general-purpose RIP software, which as described above degrades interlaced file information unsatisfactorily.

As mentioned above, a different percentage can be removed in the y-axis, to further tune exactly the total percentage of pixels removed.

If one requires further removal of pixels, one can adjust the file by removing a pixel say every 30 rows, or whatever is appropriate (randomly) to accommodate an exact dot gain percentage.

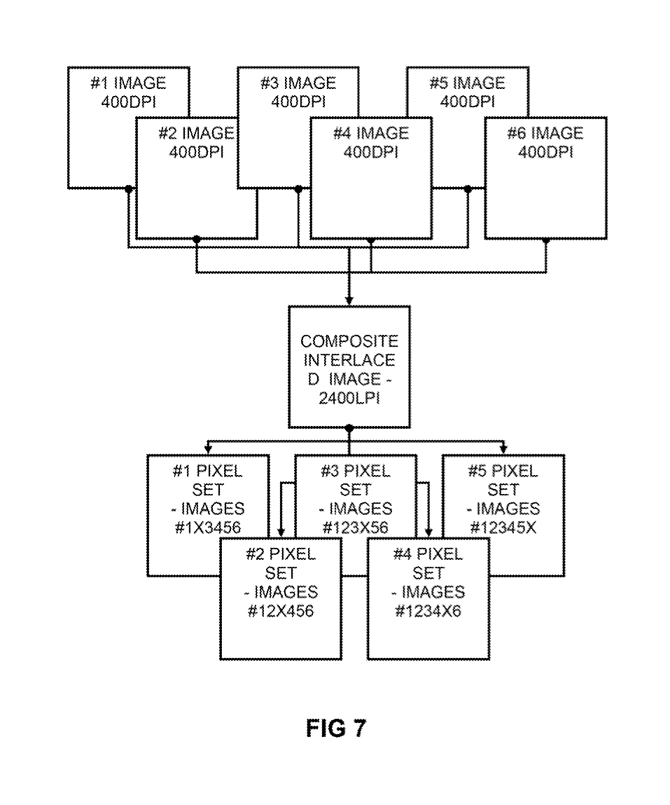

FIG. 7 schematically represents the interaction between images of a composite interlaced image file and the interlace sets with reference to the example adopted in the description above. As described, six images (#1 to #6), each of a resolution of 400 DPI, are combined in an initial interlaced image file having a resolution of 2400 DPI (6*400=2400).

Either before or after assembly of the initial interlaced image file, interlace sets are identified, either in the constituent images #1 to #6 or the initial interlaced image file. The positions of the pixels in the respective interlace sets correspond with lenticular lens positions in the final printed composite interlaced image file, according to any suitable spatial distribution as described above.

As described above with reference to Table 1, in each interlace set contributions from selected images are omitted, or in other words, selected pixels are blanked, according to a schema adopted. For the example provided, the number of images (six) exceeds the number of interlace sets (five) by one, in which case, it is arbitrarily, though conveniently, elected to retain all pixel values drawn from a particular image (#1 image), and rotate omission of successive images (#2 image to #6 image) in the respective interlace sets. Any arbitrary roster of pixel blanking can be adopted, with the result that the blanked pixels are preferably distributed between the contributing images (#1 to #6) in a manner which is relatively even.

More complicated distributions can be adopted, beside the simple sequential roster described herein for illustrative purposes, if desired. Any suitable roster within the interlace sets can be used to compensate with dot gain phenomena without comprising the integrity of the final result of lenticular printing of the modified composite interlaced image file.

Modification and improvements can be incorporated without departing from the scope of the invention.

1. A method of generating an interlaced image which is compensated for dot gain for a lenticular device, the method including: providing an initial interlaced image consisting of an array of pixels and containing a plurality of images interlaced together, each interlace consisting of at least one pixel from each image; and selectively blanking pixels from at least two of the plurality of interlaced images spatially across the initial interlaced image to generate the compensated interlaced image.

2. A method according to claim 1, wherein the step of selectively blanking pixels, alternately blanks pixels in a sequence from the at least two of the interlaced images.

3. A method according to claim 1, wherein an interlace set corresponds to a defined number of interlaces, such that the total number of interlace sets is equal to the total number of interlaces divided by a predefined divisor, the predefined divisor being the number of images interlaced together in the interlaced image or an integer less than the number of interlaced images, such that a whole number of interlace sets results, and the step of selectively blanking pixels alternately blanks pixels in a sequence across each interlace set.

4. A method according to claim 3, wherein the step of selectively blanking pixels selectively blanks pixels from a number of interlaced images equal to the predefined divisor in each interlaced set.

5. A method according to claim 1, wherein, if the predefined divisor is less than the number of interlaced images, a different set of the interlaced images are blanked in each step of selectively blanking across the interlace set.

6. A method according to claim 3, wherein, if the predefined divisor is less than the number of interlaced images, at least one alternative sequence is used across different pixel rows in each step of selectively blanking across the interlace set.

7. A method according to claim 1, further including the step of selectively blanking pixels from a predefined number of pixel rows orthogonally from the previous step of selectively blanking.

8. (canceled)

9. A compensated interlaced image generated according to the method of claim 1.

10. A security device including a lenticular lens arranged over lenticular printing of a compensated interlaced image generated in accordance with claim 9.

11. A security document including a security device according to claim 9.
